(19) United States
(12) Patent Application Publication
(10) Pub. No.: US 2019/0023397 A1
(43) Pub. Date: Jan. 24, 2019

(54) Drones with Self-Generating Function

(71) Applicant: Byeong-Chae GANG, Gwangju-si (KR)

(72) Inventor: Byeong-Chae GANG, Gwangju-si (KR)

(21) Appl. No.: 16/067,855

(22) PCT Filed: Nov. 2, 2016
(86) PCT No.: PCT/KR2016/012491

§ 371 Date: Jul. 3, 2018

(30) Foreign Application Priority Data
Nov. 2, 2015 (KR) 10-2015-0152964

(51) Int. Cl. B64C 39/02; B64D 27/24; F03D 9/32; F03D 9/25; F03D 9/11

(52) U.S. Cl. CPC B64C 39/024; B64D 27/24; F03D 9/32; F03D 9/25; F03D 9/11; F05B 2240/923; B64C 2201/042; B64C 2201/066; B64C 2201/108; F05B 2220/30; F05B 2220/7062; B64C 2201/027

(57) ABSTRACT

A drone with its own power generating function is introduced. The drone includes a central body, a battery attached to the bottom of the central body, multiple arms extended from the central body radially, drive rotors to be fitted on the top of the arms, a ring-shaped subsidiary guide positioned below the arms and supported by the multiple arms and multiple 1st generators arranged in parallel to the drive rotors on the subsidiary guide

### FIELD OF TECHNOLOGY

This invention is about a drone, more specifically, a drone with its own power generating function.

### BACKGROUND

A drone is an unmanned plane, which means “buzzing sounds (of bees etc.)” or “low murmuring sounds” dictionary, and is also called an unmanned air vehicle because it is remote-controlled by a person on the ground. In the beginning, the drone was used as a target for air force planes or antiaircraft guns in shooting practice in place of an enemy flight, but currently is used for the purpose of surveillance, monitoring and anti-submarine attack etc.

The drone is also used for various civil purposes in addition to military purposes. For example, it is used for taking pictures of a place like the crater of a volcano which is difficult for a person to approach and film or for unmanned courier service by internet shopping malls. Unmanned courier service means delivering documents, books and pizzas etc. to individuals using GPS (Global Positioning System) which identifies the location using satellites.

For the drone to be used in more various areas, sufficient flight time needs to be secured and for this, the drone needs to be fitted with large storage battery or its battery needs to be continually charged through self-power generation etc.

### DETAILED DESCRIPTION OF THE INVENTION

### Technical Problem to be Solved

This invention intends to provide a drone which can self-generate power using winds applied to the inside and outside of the drone during flight.

### Methods to Solve the Problem

According to one aspect of this invention, a drone with its own power generating function, which includes a central body, a battery attached to the bottom of the central body, multiple arms extended from the central body radially, drive rotors to be fitted on the top of the arms, a ring-shaped subsidiary guide positioned below the arms and supported by the multiple arms and multiple 1st generators arranged in parallel to the drive rotors on the subsidiary guide, is presented.

Further to this, a side cover connecting the tips of the aforementioned multiple arms, multiple holes formed on the side cover and multiple 2nd generators arranged vertically to the aforementioned drive rotors inside the holes in order to carry out power generation using the air flow entering through holes, can be included.

In addition, it can further include a board-shaped connecting subsidiary material attached to the inside circumference of the aforementioned side cover and the aforementioned 2nd generators can be attached to the board-shaped connecting subsidiary material and located in the center of the aforementioned holes.

Meanwhile, it can also include a 3rd generator installed on the aforementioned central body.

In addition, it can further include an upper guard connected to the aforementioned side cover in order to cover the upper part of the aforementioned drive rotors and the aforementioned 1st generators.

Moreover, it can include a “ [symbol] ” shaped frame which the aforementioned arms transpierce and the aforementioned drive rotors can be combined to the top of the frame and the aforementioned subsidiary guide can be combined to the top of the frame.

According to another aspect of this invention, a drone with its own power generating function, which includes a central body, a battery attached to the bottom of the central body, multiple arms extended from the central body radially, drive rotors to be fitted on top of the arms, multiple ring-shaped subsidiary guides attached to the bottom of each multiple arm corresponding to the location of each drive rotor and multiple 1st generators arranged in parallel to the drive rotors on the subsidiary guide, is presented.

Further to this, a side cover connecting the tips of the aforementioned multiple arms, multiple holes formed on the side cover and multiple 2nd generators arranged vertically to the aforementioned drive rotors inside the holes in order to carry out power generation using the air flow entering through holes, can be included.

In addition, it can further include a board-shaped subsidiary connecting material attached to the inside circumference of the aforementioned side cover and the aforementioned 2nd generators can be attached to the board-shaped connecting subsidiary material and located in the center of the aforementioned holes.

Meanwhile, it can also include a 3rd generator installed on the aforementioned central body.

In addition, it can further include an upper guard connected to the aforementioned side cover in order to cover the upper part of the aforementioned drive rotors and the aforementioned 1st generators.

Moreover, it can include a “ [symbol] ” shaped frame which is transpierced by the aforementioned arms and the aforementioned drive rotors can be combined to the top of the frame and the aforementioned subsidiary guide can be combined to the top of the frame.

### Advantageous Effects

According to the implementation example of this invention, a drone which can fly for a long-time by generating power on its own using air flow in the sky can be introduced.

### BRIEF DESCRIPTION OF THE DRAWINGS

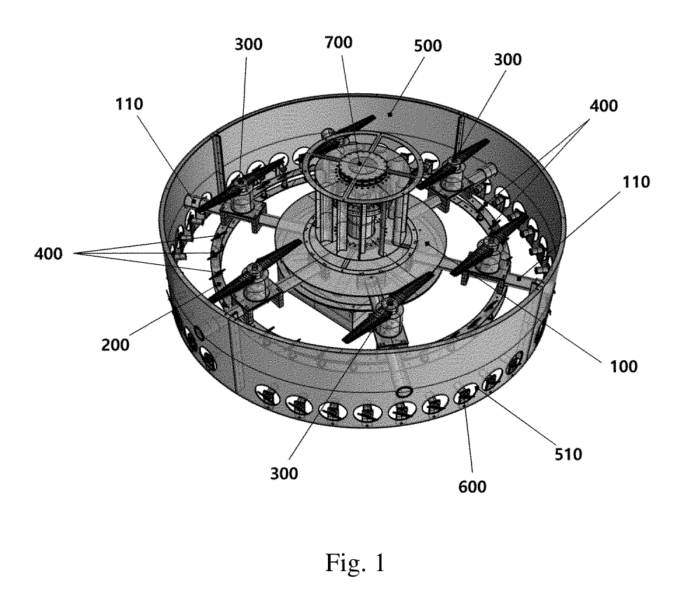

The FIG. 1 is a perspective view from above which represents the drone according to one implementation example of this invention.

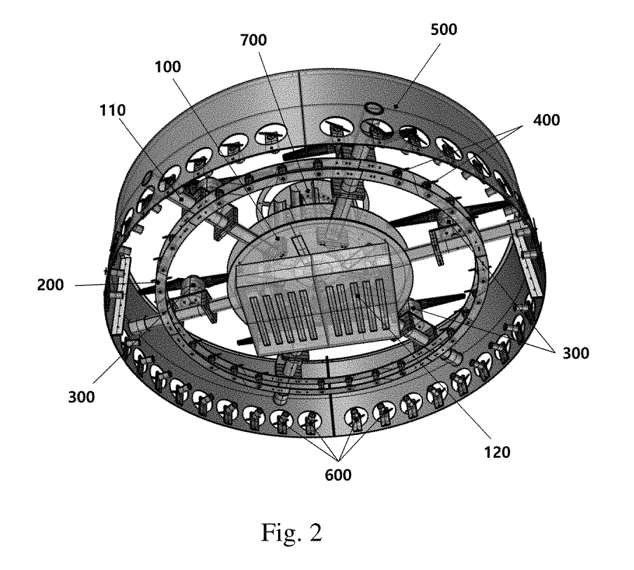

The FIG. 2 is a perspective view from below which represents the drone according to one implementation example of this invention.

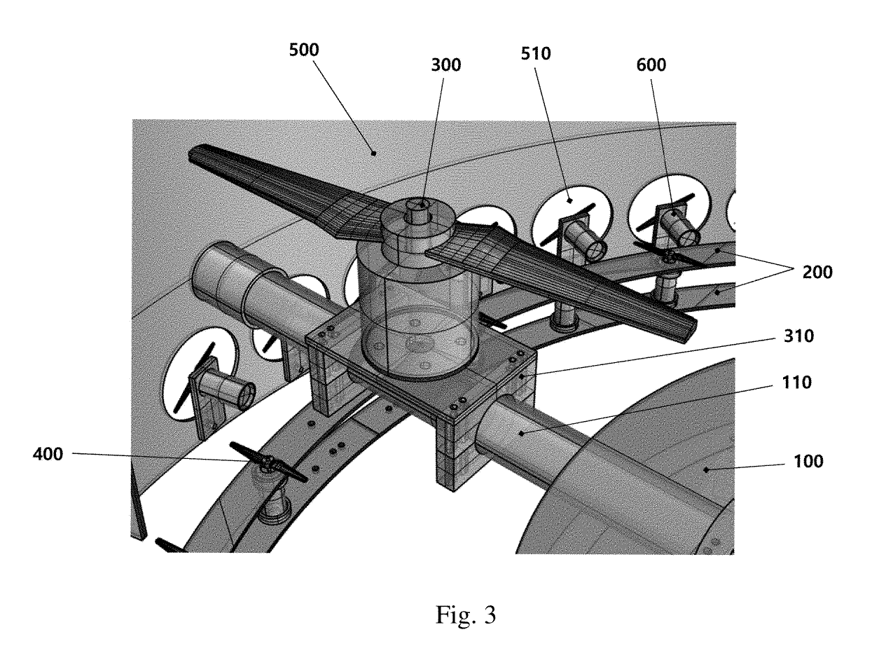

The FIG. 3 is a partial enlarged figure of the inside of the drone according to one implementation example of this invention

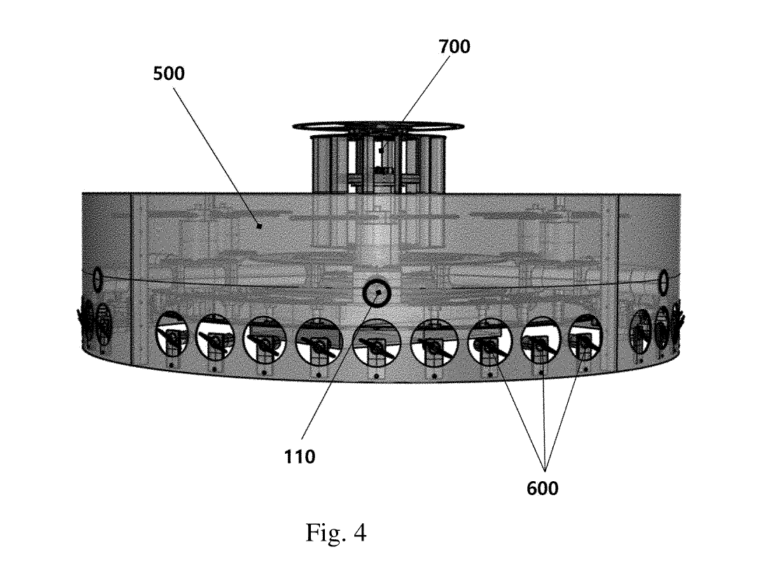

The FIG. 4 is a side view of the drone according to one implementation example of this invention.

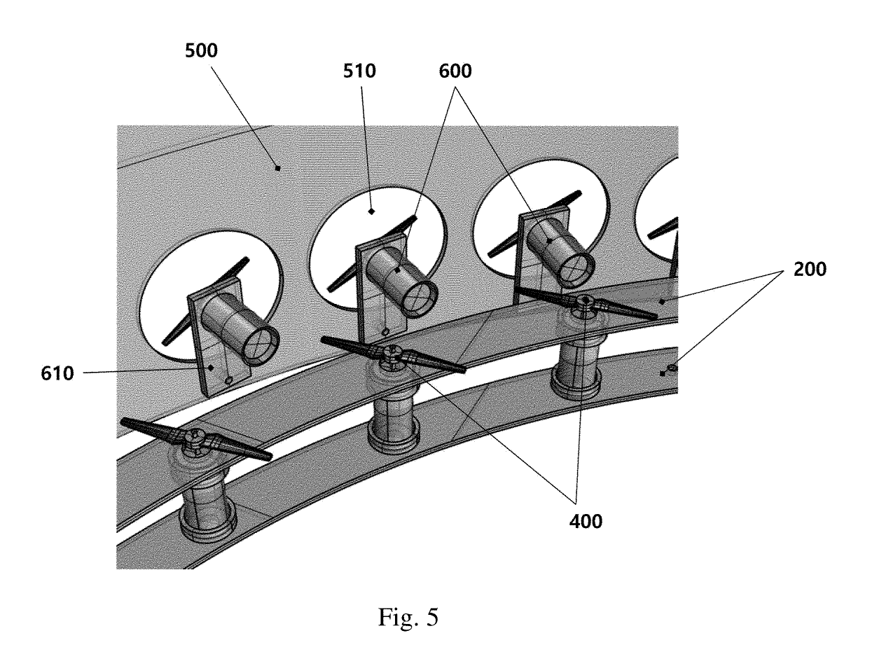

The FIG. 5 is a partial enlarged figure of the inside of the drone according to one implementation example of this invention

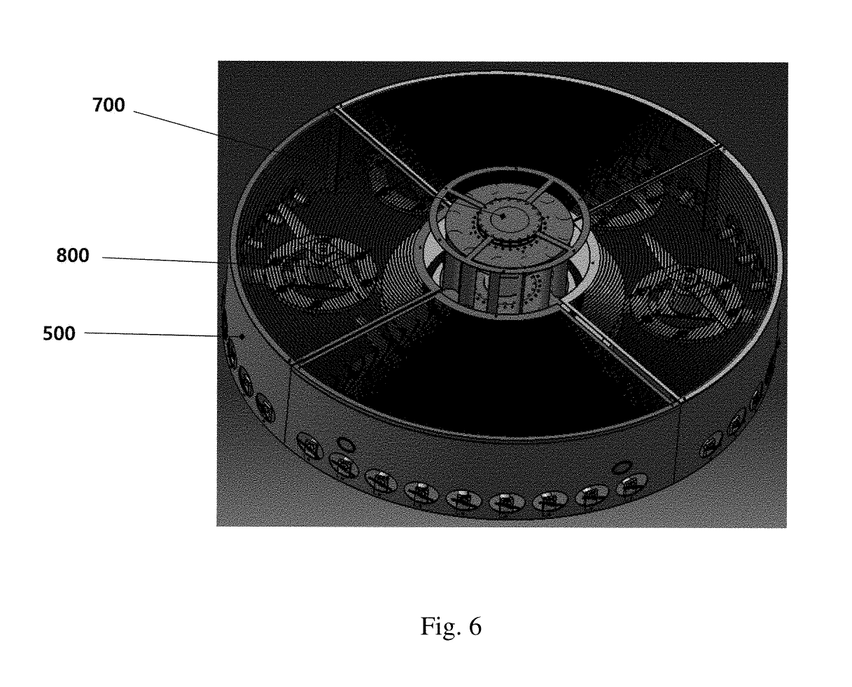

The FIG. 6 is a figure which represents the appearance of the upper guard installed to the upper part of the drone according to one implementation example of this invention.

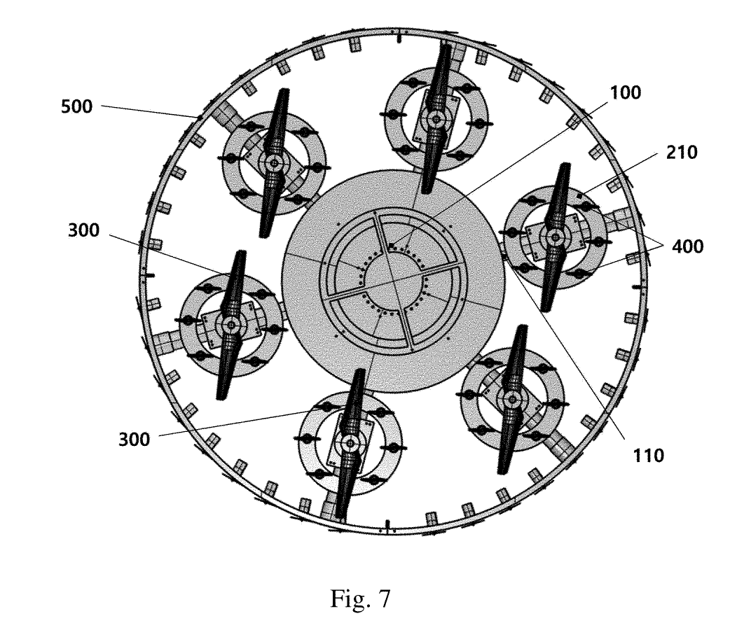

The FIG. 7 is a plane figure which roughly represent the drone according to another implementation example of this invention

### EMBODIMENTS OF THE INVENTION

This invention can have various modifications and implementation examples be changed, and in the following, specific implementation examples will be expressed in drawings and detailed description will be given. But, this is not intended to restrict this invention to specific implementation forms and should be understood to include all modifications, equivalents and alternatives belonging to the scope of idea and technology of this invention. In describing this invention, in case that a specific description of relevant publicized technology is considered to obscure the essence of this invention, the detailed description can be omitted.

The terms like “1^{st}, 2^{nd} etc.” can be used to describe various components but those components shouldn't be restricted by those terms. Those terms are only used for the purpose of differentiating one component from another component.

The terms used in is for describing certain implementation examples, not intended for restricting this invention. Singular forms include plural forms unless otherwise mentioned clearly in the context. The terms like “include” or “have” used in this application are intended to mean that a characteristic, a number, a step, an action, a component, a part or a combination thereof stated in the specification exists, and shouldn't be interpreted to exclude the possibility of existence or addition of one or more other characteristics, numbers, steps, actions, components, parts or combinations thereof in advance.

Below, desirable implementation examples of a drone with its own power generating function according to this invention will be described in detail with reference to attached drawings, and in describing with reference to attached drawings, identical numbers will be given to identical or corresponding components and redundant description will be omitted.

First of all, the structure and operation of the drone according to one implementation example of this invention are as follows. The FIG. 1 is a perspective view from above which represents the drone according to one implementation example of this invention and the FIG. 2 is a perspective view from below. With reference to the FIGS. 1 and 2, a central body (100), arms (110), a battery (120), a subsidiary guide (200), drive rotors (300), 1st generators (400), a side cover (500), holes (510), 2nd generators (600), a 3rd generator (700) are presented.

The drone according to this implementation example includes a central body (100), a battery (120) attached to the bottom of the central body (100), multiple arms (110) extended from the central body (100) radially, drive rotors (300) to be fitted on the top of the arms (110), a ring-shaped subsidiary guide (200) positioned below the arms (120) and supported by the multiple arms (120) and multiple 1st generators (400) arranged in parallel to the drive rotors (300) on the subsidiary guide (200). And base on this structure, the drone can realize wind power generation by using air flow taking place inside the drone.

The central body (100) is located at the center of the entire structure of the drone. The central body (100) can be equipped with various components necessary for the flight of the drone such as a control device (no drawing) which controls the overall operation of the drone, a signal receiving device (no drawing) which receives operation signals from a user, a battery (120) and various power supply lines.

The arms (110) take a shape of extending from the central body (100) radially. The number of arms (110) can vary according to the number of drive rotors (300) for the flight of the drone, but in the FIG. 1, 6 arms (110) are shown.

A the specific location of the arms (110), the drive rotors (300) are fitted for the flight of the drone. The drive rotors (300) comprehensibly refer to motors generating power for the flight of the drone and wings. The drive rotors (300) realize the flight of the drone by rotating with the power supplied from the battery (120) fitted to the central body (100).

Meanwhile, for the drive rotors (300) to be easily combined to the arms (110), as shown in the FIG. 3, a separate “ [symbol] ” shaped frame which is transpierced by the arms (110) is installed in the structure that it is supported by the drive rotors (300) being combined to the top of the frame.

In addition, ring-shaped subsidiary guides (200) are fitted to the drone according to this implementation as shown in FIGS. 1 and 2. The subsidiary guides (200) are installed away from the central body (100) by a certain distance. In order to maintain such structure easily, the subsidiary guides (200) can be combined to the bottom of the frame (310) to which the drive rotors (300) are combined.

On the subsidiary guides (200), multiple 1st generators (400) are arranged in parallel direction to the drive rotors (300). Since the subsidiary guides (200) take a ring shape surrounding the central body (100), the multiple 1st generators (400) are also arranged in the ring shape surrounding the central body (100). The fact that the 1st generators (400) are arranged in parallel direction to the drive rotors (300) means that each wing is arranged in parallel as shown in the FIGS. 1 to 3 (In other words, the axes of rotation are all arranged in vertical direction).

As such, if the 1st generators (400) are arranged in parallel direction below the drive rotors (300), the wings of the 1st generators (400) can rotate by the wind pressure occurring downwards by the drive rotors (300) and the drone can realize self-power generation by using such rotating power. The power generated by the 1st generators (400) is supplied to the battery (120) or a separate electric condenser through a power line (no drawing) and charges the battery (120).

Meanwhile, a low cylinder-shaped side cover (500) can be connected to the tips of the multiple arms (110). On the side cover (500) are formed multiple holes (510) and 2nd generators (600) are arranged vertically to the drive rotors (300) inside the holes (510). The fact that the 2nd generators (600) are arranged in vertical direction to the drive rotors (300) means that each wing is arranged vertically as shown in the FIG. 3 (In other words, the axes of rotation of the drive rotors (300) are arranged vertically and the axes of rotation of the 2nd generators (600) are arranged horizontally).

As such, if the 2nd generators (600) are arranged vertically to the drive rotors (300), the wind power applied to the drone in vertical direction is used for power generation by the 1st generators (400) and the wind power applied to the drone in horizontal direction is used for power generation by the 2nd generators (600). In conclusion, by using all environments given the drone for self-power generation, it is possible to maximize the efficiency of power generation.

More specifically, the 2nd generators (600) is a means for realizing power generation by using the wind entering through the holes (510) formed on the side cover (500), it can be combined through a board-shaped subsidiary connecting material (610) attached to the inside circumference of the side cover (500). By this, the 2nd generators (600) can be located in the center of the holes (510).

The higher the altitude is, the stronger the wind is. Since such strong wind is applied to the side of the drone, sufficient power is expected to be secured through the 2nd generators (600) when the drone is flying at high altitude. The power generated by the 2nd generators (600) is supplied to the battery (120) or a separate electric condenser through a power line (no drawing) and charges the battery (120).

The FIG. 4 is a side view of the drone according to one implementation example of this invention. The FIG. 4 shows the appearance that multiple holes (510) are formed in a certain interval on the side cover (500) and the 2nd generators (600) are arranged at every hole (510).

Meanwhile, a 3rd generator (700) can be installed on the aforementioned central body (100). The 3rd generator (700) realizes power generation by using the wind applied to the drone in vertical direction just like the aforementioned 1st generators (400), and while the 1st generators (400) realizes power generation with wind pressure occurring in vertical direction by the drive rotors (300), the 3rd generator (700) plays a function of realizing power generation with wind pressure occurring by natural winds. The power generated by the 3rd generator (700) is supplied to the battery (120) or a separate electric condenser through a power line (no drawing) and charges the battery (120).

In addition, as shown in the FIG. 6, the drone according to this implementation example can further have an upper guard (800) covering the drive rotors (300) and the 1st generators (400). The upper guard (800) can take a disk shape with the center open in order to expose the 3rd generator (700) outside and its circumference can be supported by connecting to the side cover (500). With this upper guard (800), it is possible to prevent various irregularities etc. from entering the inside of the drone and obstructing the operation of the drive rotors (300) etc. when the drone is flying. The upper guard (800) can be made of a mash material for smooth flow of air.

In the above, a drone according to one implementation example of this invention was described and in the below, a drone according to another implementation example of this invention will be described with reference to the FIG. 7. The FIG. 7 is a plane figure which roughly represent the drone according to another implementation example of this invention. With reference to the FIGS. 1 and 2, a central body (100), arms (110), a subsidiary guide (210), drive rotors (300), 1st generators (400), a side cover (500) are presented.

The drone according to this implementation example has a major difference in that multiple ring-shaped subsidiary guides (210) are located on each arm (110) in comparisons to the drone shown in the FIGS. 1 to 6. More specifically, the ring-shaped subsidiary guides (210) are arranged below each drive rotor (300) and the 1st generators (400) are installed on the subsidiary guides (210). With this structure, it is possible to enhance the efficiency of power generation by utilizing the wind pressure generated by each drive rotor (300) more faithfully for self-power generation

Since the remaining structure except for the shape of the subsidiary guides (210) and the following arrangement of the 1st generators (400) is identical/similar to the implementation example described through the FIGS. 1 to 6, refer to the above description for the specific structure of the other parts.

As for the operation of the drone of one implementation example of this invention, the drone has an algorithm to use the wind effectively. More specifically, it is possible to monitor the speed and direction of the wind outside etc. by using the propellers of the motors of the 1st generators, the 2nd generators or the 3rd generator of the drone (1st stage). The 2nd generators can sense the speed and direction of the wind entering from outside more accurately with horizontal axes.

Next, the drone can adjust the altitude based on the information such as information monitored at the previous stage and information on the volume of power generation etc. (2nd stage). For example, in case that more power generation is required, it can be controlled by moving the drone to high altitude with relatively strong wind speed.

Meanwhile, in case that the drone cannot fly steadily due to excessive wind at high altitude, it is possible to move the drone to the altitude at which steady flight is possible based on the monitored information of the speed and direction of the wind outside (3rd stage). In this case, the drone may be moved to the previous altitude of the 1rst stage.

In case that the drone can generate sufficient power at the altitude of the 2nd stage, control the drone to move to the location and altitude of its initial task (4th stage).

On the other hand, the data on of the speed or direction of the wind by altitude can be stored and used for power generation at the time of next flight. More specifically, it is possible to gather data on the altitude at which the drone can generate power steadily and most efficiently. For example, high altitude with excessive change of wind direction can have less efficiency of power generation than low altitude without change of direction due to higher harmonic wave in generation system. In addition, in case of excessive change of wind direction, it can consume pore power to control the drone steadily. Further to this, the data on of the speed, direction of the wind and altitude etc. can be stored on a computer by synchronous or non-synchronous method. Meanwhile, the altitude at which the drone can fly can be limited within the scope allowed by law, but not necessarily.

### Methods to Implement the Invention

In the above, desirable implementation examples were described with reference. However, anyone with ordinary knowledge in the technological area to which this invention belongs can make various modifications and changes from these examples within the idea and scope of this invention stated in the scope of patent claims below.

Many implementation examples apart from aforementioned implementation examples are included in the scope of patent claims of this invention.

### INDUSTRIAL APPLICABILITY

According to the implementation examples of this invention, a drone which can fly for a long time by generating power on its own using air flow in the sky can be introduced.

1. A drone comprising
a central body;
a battery attached to the bottom of the central body;
multiple arms extended from the central body radially;
drive rotors to be fitted on the top of the arms;
a ring-shaped subsidiary guide positioned below the arms and supported by the multiple arms; and
multiple 1st generators arranged in parallel to the drive rotors on the subsidiary guide.

2. The drone according to claim 1, further comprising
a side cover connecting the tips of the aforementioned multiple arms;
multiple holes formed on the side cover; and
multiple 2nd generators arranged vertically to the aforementioned drive rotors inside the holes in order to carry out power generation using the air flow entering through holes.

3. The drone according to claim 2, further comprising
a board-shaped connecting subsidiary material attached to the inside circumference of the aforementioned side cover, and
has a characteristic that the aforementioned 2nd generators are attached to the board-shaped connecting subsidiary material and is located in the center of the aforementioned holes.

4. The drone according to claim 1, further comprising
a 3rd generator installed on the aforementioned central body.

5. The drone according to claim 2, further comprising
an upper guard connected to the aforementioned side cover in order to cover the upper part of the aforementioned drive rotors and the aforementioned 1st generators.

6. The drone according to claim 1, further comprising
a “ [symbol] ” shaped frame which is transpierced by the aforementioned arms and
has a characteristic that the aforementioned drive rotors are combined to the top of the frame and the aforementioned subsidiary guide is combined to the top of the frame.

7. A drone comprising
a central body;
a battery attached to the bottom of the central body;
multiple arms extended from the central body radially;
drive rotors to be fitted on top of the arms;
multiple ring-shaped subsidiary guides attached to the bottom of each multiple arm corresponding to the location of each drive rotor; and
multiple 1st generators arranged in parallel to the drive rotors on the subsidiary guide.

8. The drone according to claim 7, further comprising
a side cover connecting the tips of the aforementioned multiple arms;
multiple holes formed on the side cover; and
multiple 2nd generators arranged vertically to the aforementioned drive rotors inside the holes in order to carry out power generation using the air flow entering through holes.

9. The drone according to claim 8, further comprising
a board-shaped connecting subsidiary material attached to the inside circumference of the aforementioned side cover, and
has a characteristic that the aforementioned 2nd generators are attached to the board-shaped connecting subsidiary material and is located in the center of the aforementioned holes.

10. The drone according to claim 7, further comprising
a 3rd generator installed on the aforementioned central body.

11. The drone according to claim 8, further comprising
an upper guard connected to the aforementioned side cover in order to cover the upper part of the aforementioned drive rotors and the aforementioned 1st generators.

12. The drone according to claim 7, further comprising
a “ [symbol] ” shaped frame which is transpierced by the aforementioned arms and
has a characteristic that the aforementioned drive rotors are combined to the top of the frame and the aforementioned subsidiary guide is combined to the top of the frame.
